(19) United States
(12) Patent Application Publication
(10) Pub. No.: US 2009/0098258 A1
(43) Pub. Date: Apr. 16, 2009

(54) DISPOSABLE BUTTER DISH

(76) Inventor: Rosemarie Arnold, Saddle River, NJ (US)

Correspondence Address: HISCOCK & BARCLAY, LLP, 2000 HSBC PLAZA, 100 Chestnut Street, ROCHESTER, NY, 14604-2404, US

(21) Appl. No.: 11/870,492

(22) Filed: Oct. 11, 2007

(51) Int. Cl. B65D 85/74; A23C 15/18

(52) U.S. Cl. 426/115; 426/664

(57) ABSTRACT

The invention includes a disposable container with a lid and a base. The base includes an amount of seal-forming liquid, such as water. The lid includes a butter reservoir and cooperates with the base to enclose the butter reservoir and the water. The water and the butter reservoir form a seal to keep butter in the butter reservoir fresh at room temperature.

### FIELD OF THE INVENTION

This invention relates to a disposable container for butter and the like adapted to keep butter fresh at room temperature.

### BACKGROUND OF THE INVENTION

Typically, butter and similar substances are kept fresh by refrigeration. The reduced temperature extends the life of the butter, but it also hardens the butter, which makes it less convenient to use. The cold butter is difficult to remove from the container and difficult to spread on food. Consumers therefore must let the butter warm up and soften before use. Examples of refrigerated butter serving dishes are shown in U.S. Pat. No. 1,731,604 to Allen and U.S. Pat. No. 3,240,030 to Peters, et al. Allen's butter server places pads of butter in a butter holder surrounded by ice. The butter serving dish of Peters, et al. places pads of butter on a tray in close proximity to a cooling tower that contains a refrigerant such as an ice cube. A farther example of a refrigerated butter dish is shown in U.S. Pat. No. 4,005,586 to Lyons. This butter dish contains the butter in a chamber in the cover that places the butter into close proximity to crushed ice contained in a receptacle that cooperates with the cover.

In some cases a reusable ceramic butter dish having features for keeping the butter fresh at room temperature is used instead of refrigeration. This dish has a bell-shaped lid that contains the butter and fits within the container wall. The container also includes an amount of water that seals the opening of the bell-shaped lid when the lid is placed within the container walls to protect the butter from the ambient air. However, these reusable ceramic dishes require maintenance such as cleaning before replacing the butter and frequent replacement of the water. Further, packing butter into the lid is inconvenient and inefficient due to air pockets that may form.

Certain disposable or compostable containers, such as the one described in US Pat. No. 5,736,204 to Suskind, are convenient to use. However, such disposable containers must be refrigerated in order to keep the butter fresh, thus the butter is difficult to remove from the container and difficult to spread on food.

Therefore, a butter container that keeps the butter fresh without refrigeration, but that is also convenient to use is desired.

### SUMMARY OF THE INVENTION

The invention comprises, in one form thereof, a disposable container including a base having a liquid reservoir, the liquid reservoir configured to contain a seal-forming liquid, and a lid having a butter reservoir, the lid configured to cooperate with the base to enclose the butter reservoir and the liquid reservoir, and configured to provide a seal when the seal-forming liquid is present. The base and the lid comprise a disposable material, the base and the lid configured to be disposed of after a single filling with butter and subsequent removal of the butter.

In another form, the invention includes a method for operating a room temperature storage device for butter. The method comprises the steps of purchasing a disposable container as described above, the disposable container having refrigerated butter in the butter reservoir, adding an amount of a seal-forming liquid in the liquid reservoir of the disposable base, the amount of seal-forming liquid sufficient to form a seal when the disposable lid and the disposable base are assembled, and separating the lid from the base thereby unsealing the butter reservoir from the seal-forming liquid to provide access to the butter reservoir.

In still another form, the invention includes a method for storing butter at room temperature in a disposable container. The method comprises the steps of providing a disposable container having a disposable base with a liquid reservoir and a disposable lid with a butter reservoir, the lid cooperating with the base to enclose the butter reservoir and the liquid reservoir, placing butter in the butter reservoir, instructing a consumer to place an amount of the seal-forming liquid in the liquid reservoir of the disposable base, the amount of seal-forming liquid sufficient to form a seal when the disposable lid and the disposable base are assembled, and refrigerating the butter in the butter reservoir as required to preserve the butter prior to the addition of the seal-forming liquid.

An advantage of the present invention is that the disposable container keeps butter fresh and spreadable at room temperature without requiring the inconvenienit maintenance of the container.

### BRIEF DESCRIPTION OF THE DRAWINGS

The present invention is disclosed with reference to the accompanying drawings, wherein:

FIG. 1 is an isometric view of a container according to the present invention; and

FIG. 2 is a cross-sectional view of the container of FIG. 1.

Corresponding reference characters indicate corresponding parts throughout the several views. The example set out herein illustrates one embodiment of the invention but should not be construed as limiting the scope of the invention in any manner.

### DETAILED DESCRIPTION OF THE PREFERRED EMBODIMENTS

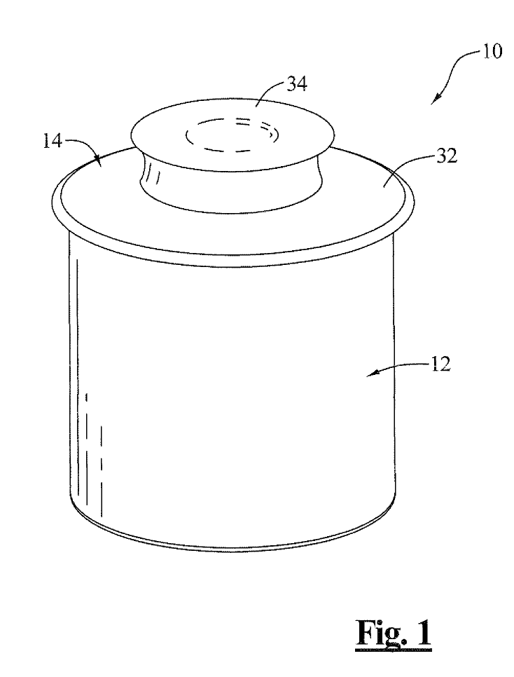

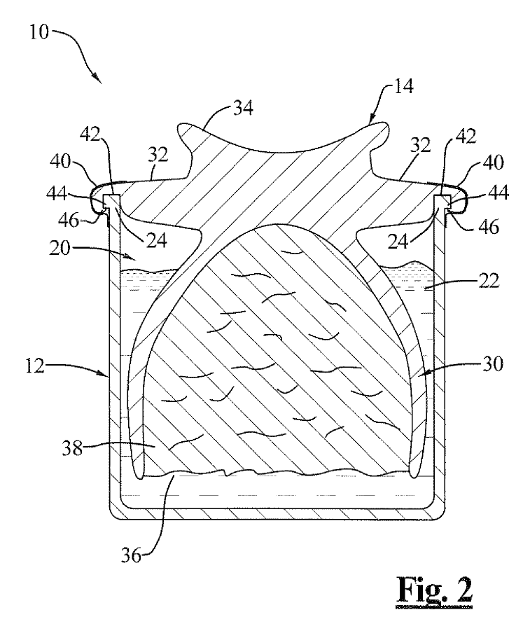

The disposable butter container of the present invention is show in FIGS. 1 and 2. The container 10 includes a base 12 and a bell-shaped lid 14, wherein the base 12 and the lid 14 are made of an inexpensive, disposable material. In a preferred embodiment, the lid 12 and the base 14 are made of a durable, temperature resistant plastic that is sufficiently inexpensive that the container 10 is disposable. In another embodiment, the lid 12 and/or the base 14 comprise a water-resistant or waterproof paper-based material, such as a heavy paper or cardboard coated with wax or plastic. The material may further be recyclable. Even further, the material may be insulating, and the outer surfaces of the lid and the base may be reflective to thermal radiation. For example, the outer surfaces may be coated with a predominantly white paint or enamel, or the surface may be laminated with a reflective material such as the metalized reflective polyester film sold under the trademark, Mylar. The container 10 is shown in the figures as having a generally cylindrical shape; however, the container 10 may have substantially any shape, such as one having a polygonal cross-section or one in the shape of a figure, such as an animal. Further, the container 10 may be decorated, labeled, or both, such as to coordinate with a particular theme and to indicate the brand and type of butter included in the container. In an example, the container 10 is decorated according to a particular time of year, such as a season or a holiday.

The base forms a liquid reservoir 20 for a seal-forming liquid 22, such as water. The base further includes a rim 24 that engages the lid 14.

The lid 14 includes a butter reservoir 30, a flange 32, and a handle 34, While the butter reservoir 30 is shown in the figures as having a bell shape, alternative shapes may also be used. The butter reservoir 30 includes an opening 36 that provides access to the butter or other substance contained in the butter reservoir 30. The butter reservoir 30 is sized so as to displace the seal-forming liquid 22 sufficiently to form a seal around the opening 36 between the seal-forming liquid 22 and the walls of the butter reservoir 30. In a preferred embodiment, the seal is substantially air-tight.

In a particular embodiment, the container 10 is pre-packaged by a manufacturer and sold to the consumer as a package containing butter 38. In this embodiment, the lid is secured to the base such as by a removable plastic wrap 40 covering at least the interface between the lid 14 and the base 12. The plastic wrap 40 may be removed after purchase and prior to use. In addition to, or alternatively to, the plastic wrap 40, the lid 14 may snap on to the rim 24 in a snap connection. As shown in FIG. 2, the flange 32 defines a recess 42 that receives the rim 24, and the rim 24 includes a ridge 44 that engages a lip 46 on the flange 32. Alternatively, the lid 12 and the base 14 may include cooperating threads so that the lid may screw onto the base.

In use, the consumer purchases the container 10 having the particular brand and type of butter that is desired. The types of butter that may be contained within the butter reservoir 30 include, but are not limited to, sweet cream butter, cultured cream butter, butter with salt or without, whipped butter, and enhanced butter, such as butter containing sun dried tomatoes or herbs. Other substances, such as cream cheese or a butter substitute, may also be used in lieu of butter in the butter reservoir 30. In the preferred embodiment, the butter is kept fresh by refrigeration until the seal-forming liquid 22 is added after the packaged container is purchased.

Prior to the first use after purchase, the consumer removes the plastic wrap 40 or other sealing means and removes the lid 14 from the base 12 to access the liquid reservoir 20. The consumer then adds an amount of the seal-forming liquid 22 sufficient to form seal with the walls of the butter reservoir 30. For example, the consumer may add ⅓ cup of water for a small container 10. The consumer then replaces the lid 14 in the base 12 so that the seal-forming liquid 22 forms a seal around the walls of the butter reservoir 30 and the surface of the butter 38, and allows the butter to soften without refrigeration while the seal of the seal-forming liquid 22 keeps the butter fresh. Once the butter has softened, the consumer may remove the lid 14 to access butter 38 as desired, After removing a portion of the butter for spreading on food or cooking, the consumer once again replaces the lid 14 in the base 12 so that the seal-forming liquid 22 forms a seal around the walls of the butter reservoir 30 and the surface of the butter 38.

Thus the seal-forming liquid 22 protects the butter from air and allows the user to store the butter at a temperature that keeps the butter at a spreadable consistency, such as room temperature. This makes the butter easier to remove from the container and easier to spread than butter stored at lower temperatures, such as in a refrigerator. The consumer may replace the seal-forming liquid 22 as needed. Further, the user may supplement the seal-forming liquid 22 if needed as the butter is consumed over time or if the liquid evaporates or spills. Once the butter in the butter reservoir is fully consumed or has expired, the consumer simply discards the container 10 and replaces it with a new one. There is no cleaning of the container or refilling of the butter reservoir required.

It should be particularly noted that while the invention has been described generally for use with butter, other substances may also be used in conjunction with the invention wherein the user desires to store the substance in a sealed reservoir to protect it from exposure to the air.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A disposable container, comprising:
a base having a liquid reservoir, the liquid reservoir configured to contain a seal-forming liquid;
a lid having a butler reservoir, the lid configured to cooperate with the base to enclose the butter reservoir and the liquid reservoir, and configured to provide a seal when the seal-forming liquid is present;
the base and the lid comprising a disposable material, the base and the lid configured to be disposed of after a single filling with butter and subsequent removal of the butter.

2. The disposable container of claim 1, wherein the lid is substantially bell-shaped.

3. The disposable container of claim 1, further comprising an amount of seal-forming liquid in the liquid reservoir.

4. The disposable container of claim 3, the butter container defining an opening wherein the seal-forming liquid forms a substantially air-tight seal with butter reservoir around the opening.

5. The disposable container of claim 3, wherein the seal-forming liquid comprises water.

6. The disposable container of claim 1, the base and the lid comprising durable, temperature resistant plastic.

7. The disposable container of claim 1, wherein at least one of the base and the lid comprises a water-resistant paper-based material.

8. The disposable container of claim 1, wherein at least one of the base and the lid comprises a waterproof paper-based material.

9. The disposable container of claim 1, the base and the lid comprising a material that reflects thermal radiation.

10. The disposable container of claim 1, further comprising an amount of butter.

11. The disposable container of claim 10, the base and the lid being sealed together with a removable plastic wrap.

12. The disposable container of claim 1, the lid defining a recess and the base having a rim, the recess receiving the rim in a snap connection.

13. A method of operating a room temperature storage device for butter, comprising the steps of:
a) purchasing a disposable container of claim 1, said disposable container having refrigerated butter in the butter reservoir;
b) adding an amount of a seal-forming liquid to the liquid reservoir of the disposable base, the amount of seal-forming liquid sufficient to form a seal when the disposable lid and the disposable base are assembled; and
c) separating the lid from the base thereby unsealing the butter reservoir from the seal-forming liquid to provide access to the buffer reservoir.

14. The method of claim 13, further comprising the step of removing a portion of the butter.

15. The method of claim 13, further comprising the step of re-assembling the lid and the base thereby reforming the seal between the butter reservoir and the seal-forming liquid.

16. The method of claim 13 further comprising the step of discarding the disposable container.

17. A method of storing butter at room temperature in a disposable container, comprising the steps of:
a) providing a disposable container having a disposable base with a liquid reservoir and a disposable lid with a butter reservoir, the lid cooperating with the base to enclose the butter reservoir and the liquid reservoir;
b) placing butter in the butter reservoir;
c) instructing a consumer to place an amount of the seal-forming liquid in the liquid reservoir of the disposable base, the amount of seal-forming liquid sufficient to form a seal when the disposable lid and the disposable base are assembled; and
d) refrigerating the butter in the butter reservoir as required to preserve the butter prior to the addition of the seal-forming liquid.

18. The method of claim 17, further comprising the step of sealing the lid to the base with a removable plastic wrap.
